(19) United States
(12) Patent Application Publication
(10) Pub. No.: US 2019/0283904 A1
(43) Pub. Date: Sep. 19, 2019

(54) METHOD AND APPARATUS FOR DETERMINING AIRCRAFT ENGINE MAINTENANCE STATUS USING FAN BEAM EMISSION TOMOGRAPHY

(71) Applicants: Yudaya R. Sivathanu, West Lafayette, IN (US); Jongmook Lim, West Lafayette, IN (US)

(72) Inventors: Yudaya R. Sivathanu, West Lafayette, IN (US); Jongmook Lim, West Lafayette, IN (US)

(21) Appl. No.: 16/358,691

(22) Filed: Mar. 19, 2019

Related U.S. Application Data
(60) Provisional application No. 62/644,699, filed on Mar. 19, 2018.

(51) Int. Cl. B64F 5/60; B64F 5/40; G01N 21/25

(52) U.S. Cl. CPC B64F 5/60; G01N 21/255; B64F 5/40

(57) ABSTRACT

A method of determining a maintenance status of an aircraft engine to be tested. The method includes measuring spectral radiation intensities at a plurality of wavelengths and at a plurality of viewing angles from an exhaust plume of an aircraft engine to be tested so as to provide a plurality of measured spectral radiation intensities. Then, converting the plurality of measured spectral radiation intensities to test planar maps of at least one of: temperature, carbon dioxide concentration, and soot volume fractions. Next, comparing each test planar map to a fiducial map so as to provide a normal distance between the test planar map and the fiducial map. Then, the normal distance is compared to at least one threshold so as to determine a maintenance status of the aircraft engine to be tested. The method reduces the cost and time needed for aircraft maintenance, while increasing safety.

### CROSS-REFERENCE TO RELATED APPLICATIONS

This application claims priority from Provisional Patent Application Ser. No. 62/644,699, filed Mar. 19, 2018, the entire contents of which is herein incorporated by reference.

### FIELD OF THE INVENTION

This invention relates generally to aircraft maintenance, and more particularly to methods and apparatuses for determining when maintenance is needed for an aircraft engine.

### BACKGROUND

Aircraft engines are regularly scheduled for maintenance to ensure safe operation of the aircraft . Such maintenance is carried out by Maintenance, Repair, and Overhaul (MRO) facilities around the world. This scheduled maintenance of an aircraft engine is typically performed after a certain amount of aircraft engine operation time, regardless of the need for such maintenance.

While an aircraft is being maintained, the aircraft is unavailable for use, which is an inherent cost of aircraft maintenance. Therefore, reducing the time needed for aircraft maintenance is one way to effectively reduce the cost of aircraft maintenance.

### SUMMARY OF THE INVENTION

The invention is a Fan Beam Emission Tomography (FBET) apparatus and method for determining the maintenance status of an aircraft engine. The FBET apparatus can be deployed directly on a tarmac or runway to evaluate the maintenance status of an aircraft engine during regular aircraft operations within a few minutes. This enables the operator to determine whether an aircraft engine requires a maintenance overhaul for safety reasons before any further operation of the aircraft, or if the aircraft engine can safely continue to be used for some period of time without a maintenance overhaul. Consequently, regular use of the FBET apparatus and method of the invention will increase the average time between aircraft engine overhauls, thereby reducing cost of aircraft operation, while also enhancing safety.

The FBET apparatus and method can be used quickly and easily to check the operating condition of aircraft engines before their scheduled maintenance date, thereby helping to ensure that there are no impending catastrophic failures, such as spalling of the thermal barrier coatings on the blades, or coking of a fuel nozzle in the engine. Thus, the FBET method and apparatus provides at least four important benefits: lower aircraft operating costs, greater aircraft fleet readiness, increased aircraft safety, and reduced aircraft engine maintenance status test times.

The FBET apparatus includes three mid-infrared imaging spectrometers with 1-D scanners to image the exhaust plumes of aircraft engines while operating on a tarmac or runway. The spectrometers with scanners are mounted on a rigid vertical frame, and data is collected and processed. Data processing includes processing the collected image data from the imaging spectrometers using deconvolution to provide planar temperature maps, gas concentration maps, and soot volume fraction maps representing a cross-section of the exhaust plume to be tested. These temperature, gas concentration, and soot volume fraction maps are compared with data models of good exhaust plumes so as to determine the maintenance status of the aircraft engine being tested, expressed as a maintenance status parameter.

A general aspect of the invention is a method of determining a maintenance status of an aircraft engine to be tested. The method includes: measuring spectral radiation intensities at a plurality of wavelengths and at a plurality of viewing angles from an exhaust plume of an aircraft engine to be tested so as to provide a plurality of measured spectral radiation intensities; converting the plurality of measured spectral radiation intensities to test planar maps of at least one of: temperature, carbon dioxide concentration, and soot volume fractions; comparing each test planar map to a fiducial map so as to provide a normal distance between the test planar map and the fiducial map; and comparing the normal distance to at least one threshold so as to determine a maintenance status of the aircraft engine to be tested.

In some embodiments, measuring spectral radiation intensities includes measuring the spectral radiation intensities using three spectrometers with scanners in front of them.

In some embodiments, the three spectrometers are mounted 120 degrees apart on a support structure configured to be placed behind an aircraft engine so as to intercept the exhaust plume of the aircraft engine while it is operating.

In some embodiments, the rigid structure has wheels configured to enable the support structure to roll across a tarmac or runway.

In some embodiments, each planar test map has a respective set of thresholds, and any test map that differs too much from the respective fiducial map will result in a maintenance status of the aircraft requiring maintenance of the aircraft engine.

In some embodiments, the maintenance status of the aircraft engine is used to schedule maintenance.

### BRIEF DESCRIPTION OF THE DRAWINGS

Many additional features and advantages will become apparent to those skilled in the art upon reading the following description, when considered in conjunction with the accompanying figures, wherein:

FIG. 1 is a schematic side view of an embodiment of the Fan Beam Emission Tomography (FBET) apparatus, showing a support apparatus with three spectrometers arranged 120 degrees apart mounted thereon, providing three beams, each beam directed orthogonally into the exhaust plume.

FIG. 2 is a block diagram of ethernet and local serial control of the Fan Beam Emission Tomography (FBET) apparatus of FIG. 1.

FIG. 3 is a grey scale spatial plot of temperature (degrees F.) as a function of position in a cross-sectional plane taken through the exhaust plume of an aircraft engine.

FIG. 4 is a grey scale spatial plot of carbon dioxide concentration (Mole fraction) as a function of position in a cross-sectional plane taken through the exhaust plume of an aircraft engine.

FIG. 5 is a grey scale spatial plot of soot volume fraction (ppm) as a function of position in a cross-sectional plane taken through the exhaust plume of an aircraft engine.

FIG. 6 is a flow chart showing the method of the invention.

### DETAILED DESCRIPTION

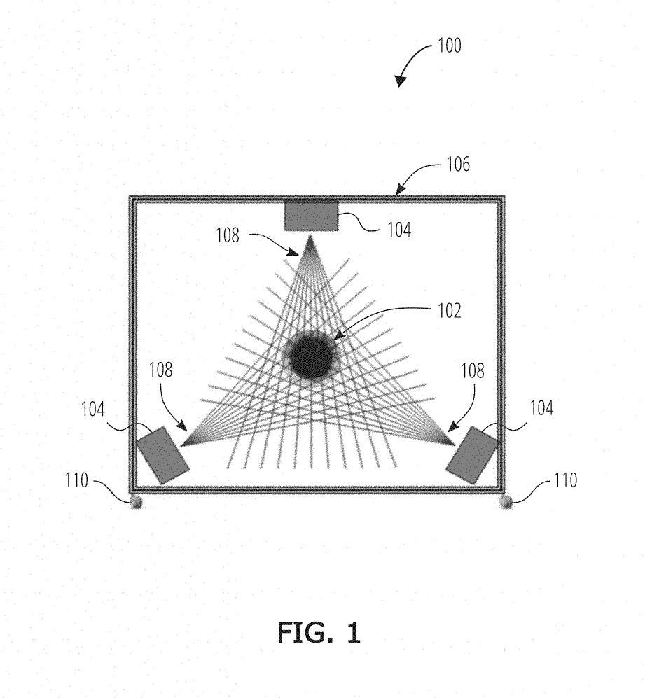

With reference to FIG. 1, an embodiment 100 of a Fan Beam Emission

Tomography (FBET) system (manufactured by En'Urga Inc, West Lafayette, Ind.) is shown. The FBET system 100 is used to measure exhaust plume temperature, gas concentrations, and soot volume fractions in a cross-sectional plane through an exhaust plume 102 of an aircraft engine (not shown).

With reference to FIG. 1, three spectrometers 104 are mounted at locations that are 120 degrees apart on a support structure 106. The support structure 106 can include a frame that is square, rectangular, round, or hexagonal, for example, so that the exhaust plume 102 of the aircraft engine is located within the center of the lines 108 of the spectrometers 104. In alternate embodiments, there can be four or more spectrometers 104 that are equally spaced apart on the support structure 106. Each spectrometer 104 is aimed at the center of the exhaust plume 102 of the aircraft engine of an aircraft that is operating so as to produce exhaust while on a runway or tarmac.

In this embodiment, the support structure 106 includes a frame that is made from aluminum or steel members. In this embodiment, the entire support structure 106 is mounted on wheels 110 so that the support structure 106 can be easily and quickly moved behind the aircraft so as to intercept the exhaust plume of an engine of the aircraft. Thus, the FBET system 100 can map the exhaust plume 102 of an aircraft engine while the aircraft is on the runway or tarmac during normal operations.

With reference again to FIG. 1, the lines 108 schematically represent 128 view angles provided by each spectrometer 104 with a scanner. All of the 128 lines representing the view angles are not shown.

The three spectrometers 104 are mid-infrared spectrometers with one dimensional scanners in front of them. In one embodiment, the three spectrometers 104 could be SPECTROLINE® Model ES200 spectrometers (Spectronics Corporation, Westbury, N.Y.), each with a one dimensional scanner SS-100 in front. In another embodiment, the spectrometers 104 can be 2-D hyperspectral imagers, such as the SPECTROLINE® 2D-100 model. The hyperspectral imager provides the image of a linear object along one axis, and a spectral image at each point of the line along the other axis of a 2-D array. As an example, the SPECTROLINE® 2D-100 hyperspectral imager provides 256 view angles and 256 wavelengths at each view angle. The spectrometers 104 or hyperspectral imagers measure the path integrated emission intensities of the exhaust plume 102 from 1.3 microns to 4.8 microns and along 128 view angles. The path integrated intensities are deconvoluted so as to provide the planar temperature, gas concentration, and soot volume fraction (ppm) as a function of x-y position. The deconvolution can be performed using a linearized form of the equation of radiative transfer in conjunction with a Maximum Likelihood Estimation method. It is understood that other devices that measure the emission spectra from the exhaust plume 102 can also be used instead of the spectrometer 104 with a 1-D scanner.

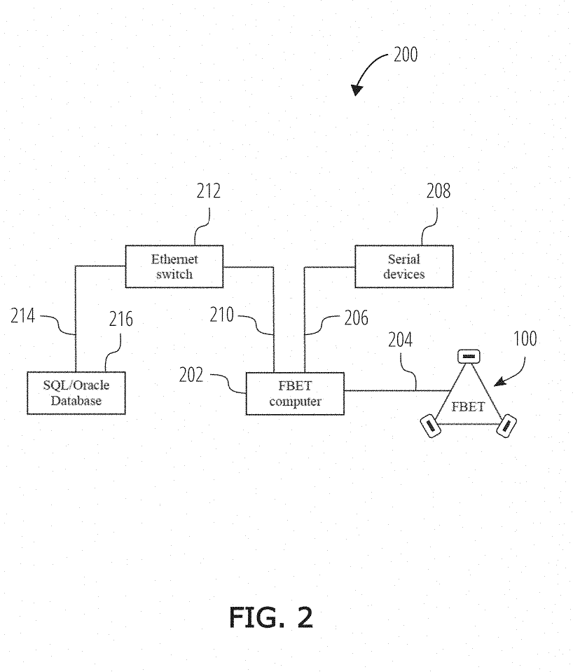

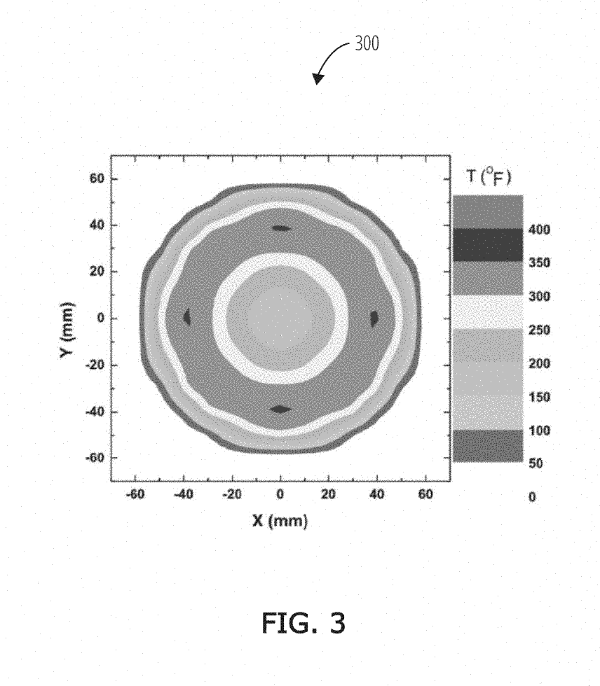

With reference to FIG. 2, a schematic block diagram shows an embodiment 200 of a typical configuration to analyze data so as to determine the health of an aircraft engine. Data collected from the aircraft engine plume 102 is analyzed so as to provide planar maps 300, 400, and 500 of temperatures, gas concentrations, and particulate volume fractions, as shown in FIGS. 3, 4, and 5, respectively. These planar maps 300, 400, 500 are compared with corresponding fiducial maps from a database that has stored maps of the plume properties of healthy engines. The comparison between the fiducial maps and the test maps is performed by calculating the normal distance, or some other parametric distance, between the maps of a healthy aircraft engine and the maps of an aircraft engine to be tested.

Normal distance definition:

$$Distance = \frac{\sqrt{{( {T}_{i , j} - {G}_{i , j} )}^{2}}}{N}$$

where:
T_{i,j}=Temperature map measured at exhaust plane
G_{i,j}=Temperature map from database of good engine
N=total number of pixels in each map

If the normal distance between a fiducial map and a test map is greater than a predetermined threshold, such as one standard deviation, then the engine is scheduled for an overhaul or a repair. The raw intensities obtained at the exhaust plume 102 can also be used to determine the health of the engines.

### Predetermined Threshold Method:

G_{i,j} is obtained from averaging 20 good engine data map images at every pixel i and j of the map image.

The normal distance from the G_{i,j} is found for the 20 map images.

The standard deviation of these normal distances is calculated.

If the measured normal distance for the test engine map is within one standard deviation from the respective good engine map, then the tested aircraft engine is fine and no maintenance action needs to be taken.

If the measured normal distance for the test aircraft engine map is more than one standard deviation and less than two standard deviations from the respective good aircraft engine (fiducial) map, then the aircraft engine needs to be watched.

If the measured normal distance for the test aircraft engine map is more than two standard deviations and less than three standard deviations from a good aircraft engine map, then the aircraft engine should be scheduled for maintenance.

If the measured normal distance for the test aircraft engine map is more than three standard deviations from a good aircraft engine map, the aircraft should be grounded.

Each fiducial map has an associated set of thresholds, such as standard deviation thresholds. Any test map that differs too much from the fiducial map of a good engine will be scheduled for maintenance. The thresholds for each map may indicate different problems with the aircraft engine.

With reference to FIG. 2, an embodiment 200 of the three spectrometer FBET system 100 of FIG. 1 is shown. The computer 202 is used to collect data from the spectrometers 104 of the system 100 via data communication line 204. The serial cable 206 is used to control serial devices 208 attached to the computer 202, such as serial devices that switch fuel flow to the aircraft engine being tested, and serial devices that send results to a printer, and serial devices that send results of data analysis to a display (not shown).

With reference again to FIG. 2, an ethernet cable 210 connects the computer 202 to an ethernet switch 212. Another ethernet cable 214 connects another computer 216 that hosts a database of fiducial maps which is used to compare the measured test intensities of temperatures, gas concentrations, and soot volume fractions to the fiducial maps stored in the database obtained from good engines. If there is any problem with an aircraft engine, the differences in the temperature, carbon dioxide concentration, and soot volume fraction values are reported to the operator.

With reference to FIG. 3, a typical map 300 of temperatures obtained at a cross-section of the exhaust plume 102 of an aircraft engine is shown. The map 300 shows temperature values in degrees Fahrenheit as a function of x-y position in a plane of the cross-section of the exhaust plume 102.

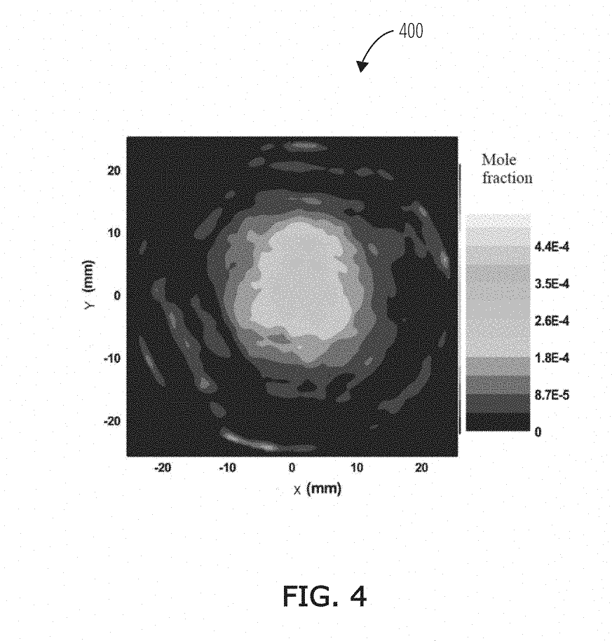

With reference to FIG. 4, a typical map 400 of carbon dioxide gas concentrations obtained at a cross-section of the exhaust plume 102 of an aircraft engine is shown. The map 400 shows carbon dioxide concentration in Mole fraction as a function of x-y position in a plane of the cross-section of the exhaust plume 102.

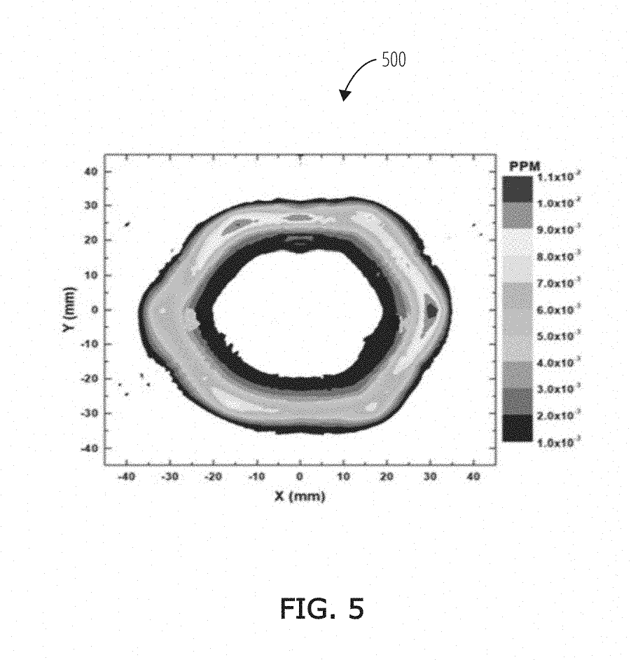

With reference to FIG. 5, a typical map 500 of soot volume fraction (ppm) obtained at the exhaust plume 102 of an aircraft engine is shown. The map 500 shows soot volume fraction in ppm as a function of x-y position in a plane of the cross-section of the exhaust plume 102.

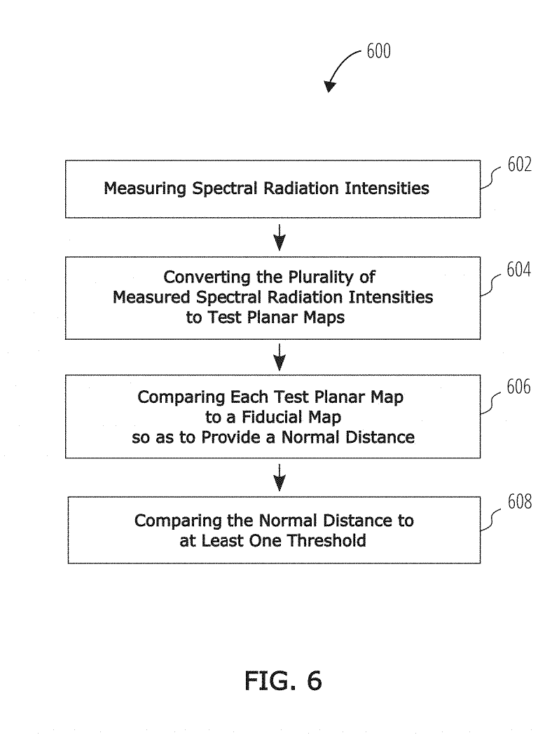

With reference to FIG. 6, the method 600 of determining a maintenance status of an aircraft engine to be tested includes: measuring spectral radiation intensities 602, then converting the plurality of measured spectral radiation intensities to test planar maps 604. Next, comparing each test planar map to a fiducial map so as to provide a normal distance 606, and then comparing the normal distance to at least one threshold 608.

It should be noted that other methods of converting the intensities to temperature, such as other linear and non-linear iteration methods can be used with the present invention, such as set forth in the articles (herein incorporated by reference in its entirety):

International Journal of Atmospheric Sciences, Volume 2013, Article ID 503727, 26 pages, entitled Radiation and Heat Transfer in the Atmosphere: A Comprehensive Approach on a Molecular Basis, Citation (APA): Bäckström, D., Johansson, R., Andersson, K., Johnsson, F., Clausen, S., & Fateev, A. (2012).

Gas Temperature and Radiative Heat Transfer in Oxy-fuel Flames. Paper presented at 37th International Technical Conference on Clean Coal & Fuel Systems. The Clearwater Clean Coal Conference, Clearwater, Fla., United States.

It will be understood by those of ordinary skill in the art that it is contemplated as within the scope of the invention to employ other imaging methods, such as methods using visible spectrometers, or visible and infrared imagers, for measuring intensities from the plume, and using them to estimate the maintenance status of an aircraft engine.

Other modifications and implementations will occur to those skilled in the art without departing from the spirit and the scope of the invention as claimed. Accordingly, the above description is not intended to limit the invention, except as indicated in the following claims.

What is claimed is:

1. A method of determining a maintenance status of an aircraft engine to be tested, the method comprising:
measuring spectral radiation intensities at a plurality of wavelengths and at a plurality of viewing angles from an exhaust plume of an aircraft engine to be tested so as to provide a plurality of measured spectral radiation intensities;
converting the plurality of measured spectral radiation intensities to test planar maps of at least one of: temperature, carbon dioxide concentration, and soot volume fractions;
comparing each test planar map to a fiducial map so as to provide a normal distance between the test planar map and the fiducial map; and
comparing the normal distance to at least one threshold so as to determine a maintenance status of the aircraft engine to be tested.

2. The method of claim 1, wherein measuring spectral radiation intensities includes measuring the spectral radiation intensities using three spectrometers with scanners in front of them.

3. The method of claim 2, wherein the three spectrometers are mounted 120 degrees apart on a support structure configured to be placed behind an aircraft engine so as to intercept the exhaust plume of the aircraft engine while it is operating.

4. The method of claim 3, wherein the rigid structure has wheels configured to enable the support structure to roll across a tarmac or runway.

5. The method of claim 1, wherein each planar test map has a respective set of thresholds, and any test map that differs too much from the respective fiducial map will result in a maintenance status of the aircraft requiring maintenance of the aircraft engine.

6. The method of claim 1, wherein the maintenance status of the aircraft engine is used to schedule maintenance.
